(19) United States
(12) Patent Application Publication
(10) Pub. No.: US 2025/0164730 A1
(43) Pub. Date: May 22, 2025

(54) CONFIGURABLE ORGANIZER SYSTEM FOR MANAGING OPTICAL FIBERS AT A TELECOMMUNICATIONS CLOSURE

(71) Applicant: CommScope Technologies LLC, Hickory, NC (US)

(72) Inventors: Bart Mattie CLAESSENS, Hasselt (BE); Jan Jozef Julia Maria ERREYGERS, Tielt-Winge (BE); Geert VAN GENECHTEN, Vorselaar (BE)

(73) Assignee: CommScope Technologies LLC, Hickory, NC (US)

(21) Appl. No.: 18/837,474

(22) PCT Filed: Feb. 1, 2023
(86) PCT No.: PCT/US2023/061791

§ 371 Date: Aug. 9, 2024

Related U.S. Application Data
(60) Provisional application No. 63/309,106, filed on Feb. 11, 2022.

(51) Int. Cl. G02B 6/44

(52) U.S. Cl. CPC G02B 6/4455; G02B 6/4442

(57) ABSTRACT

A system and/or a method for configuring an optical fiber management organizer of a telecommunications closure. The system and/or method allows common organizer pieces, such as baskets, trays and tray supports, to be used in configuring an organizer to accommodate different fiber management needs.

### CROSS-REFERENCE TO RELATED APPLICATION

This application is being filed on Feb. 1, 2023, as a PCT International application and claims the benefit of and priority to U.S. Patent Application No. 63/309,106, filed on Feb. 11, 2022, the disclosure of which is hereby incorporated by reference in its entirety.

### TECHNICAL FIELD

The present disclosure relates to the management of optical fibers in telecommunications closures.

### BACKGROUND

Fiber optic cables can be managed inside a telecommunications closure using an optical fiber management assembly, or organizer. In some closures, the organizer includes pivotally mounted trays that support optical fiber splices, splitters and other optical components. Telecommunications enclosures are typically sealable and re-enterable, defining sealed closure volumes. Such closures are often buried underground or aerially suspended from power or communications lines, such that the closures are generally designed to be both weatherproof and as compact as possible. Due to the compactness, versatility of optical fiber organization capabilities within the closure can be limited.

### SUMMARY

In general terms, the present disclosure is directed to an organizer system for managing optical fibers within a telecommunications closure.

According to certain aspects, the present disclosure is directed to a telecommunications closure that includes a configured and/or configurable organizer assembly.

According to certain aspects, the present disclosure is directed to a method of configuring an organizer assembly for managing optical fibers in a telecommunications closure.

According to certain aspects, the present disclosure is directed to an organizer system for managing optical fibers within a telecommunications closure, wherein the organizer system is configurable into any of multiple configurations of a fiber management organizer assembly.

The configuration selected can depend on the type or types of telecommunications cables entering the closure, with different configurations being better suited than others for a particular telecommunications cables scheme.

According to certain specific aspects, an optical fiber management organizer for a telecommunications closure, includes: a first basket for storing loops or partial loops of optical fibers; optical fiber management trays configured to be pivotally mounted at a first side of the first basket; and a second basket for storing loops or partial loops of optical fibers, the first basket and the second basket being configured such that the second basket can be mounted directly to a second side of the first basket at a first mounting location, the second side being opposite the first side.

According to further specific aspects, an optical fiber management organizer for a telecommunications closure, includes: a basket for storing loops or partial loops of optical fibers; a first optical fiber management tray configured to be pivotally mounted at a first side of the basket; and a second optical fiber management tray configured to be pivotally mounted at a second side of the basket, the second side being opposite to the first side, wherein the first optical fiber management tray is configured to support optical fiber splices and does not support an optical fiber signal splitter; and wherein the second optical fiber management tray is configured to support an optical fiber signal splitting component.

According to further specific aspects, an optical fiber management organizer system, includes: an optical fiber organizer configurable into each of a first configuration and a second configuration, each of the first configuration and the second configuration including: a first basket for storing loops or partial loops of optical fibers; and a first optical fiber management tray pivotally mounted at a first side of the first basket, wherein in the first configuration a second basket for storing loops or partial loops of optical fibers is mounted at a second side of the first basket, the second side being opposite the first side; and wherein in the second configuration a second optical fiber management tray is pivotally supported at the second side of the basket.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of example telecommunications equipment that can support an optical fiber management assembly according to the present disclosure.

FIG. 2 is a further perspective view of the equipment of FIG. 1.

FIG. 3 is a perspective view of a first configuration of a fiber management system, the first configuration being an example organizer assembly (also referred to, simply, as “organizer”) according to the present disclosure that can be housed in the closure of FIG. 1.

FIG. 4 is a further perspective view of the organizer of FIG. 3, with a cover of one of the fiber management trays removed.

FIG. 5 is a further perspective view of the organizer of FIG. 4.

FIG. 6 is a partially exploded view of the organizer of FIG. 4.

FIG. 7 is a further partially exploded view of the organizer of FIG. 4.

FIG. 8 is a perspective view of the organizer of FIG. 4, with two of its fiber management trays pivoted to pivoted out positions.

FIG. 9 is an enlarged view of the called-out portion in FIG. 8.

FIG. 10 is a further perspective view of the organizer of FIG. 4, with two of its fiber management trays pivoted to pivoted out positions.

FIG. 11 is an enlarged view of the called-out portion of FIG. 10.

FIG. 12 is a perspective view of a second configuration of a fiber management system, the second configuration being another example organizer assembly (“organizer”) according to the present disclosure that can be housed in the closure of FIG. 1.

FIG. 13 is a further perspective view of the organizer of FIG. 12.

FIG. 14 is a further perspective view of the organizer of FIG. 12.

FIG. 15 is a partially exploded view of the organizer of FIG. 12.

FIG. 16 is a further partially exploded view of the organizer of FIG. 12.

FIG. 17 is a further perspective view of the organizer of FIG. 12.

FIG. 18 is an enlarged view of the called-out portion in FIG. 17.

FIG. 19 is perspective view of a piece of the organizers of FIGS. 4 and 12, the piece being of unitary construction.

FIG. 20 is a further perspective view of the piece of FIG. 19.

FIG. 21 is a perspective view of another piece of the organizer of FIG.12, the piece being of unitary construction.

FIG. 22 is a perspective view of a configuration of another fiber management system according to the present disclosure, the configuration being another example organizer assembly (“organizer”) that can be housed in the closure of FIG. 1.

FIG. 23 is a further perspective view of the organizer of FIG. 22, with the cover of one of the fiber management trays removed.

FIG. 24 is a further perspective view of the organizer of FIG. 23.

FIG. 25 is a partially exploded view of the organizer of FIG. 23.

FIG. 26 is a further partially exploded view of the organizer of FIG. 23.

FIG. 27 is a perspective view of one of the pieces of the organizer of FIG. 23.

FIG. 28 is a further perspective view of the piece of FIG. 27

FIG. 29 is a perspective view of a base to which the organizer of any of FIG. 4, 12, or 23 can be snap-connected.

FIG. 30 is a further perspective view of the base of FIG. 29.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

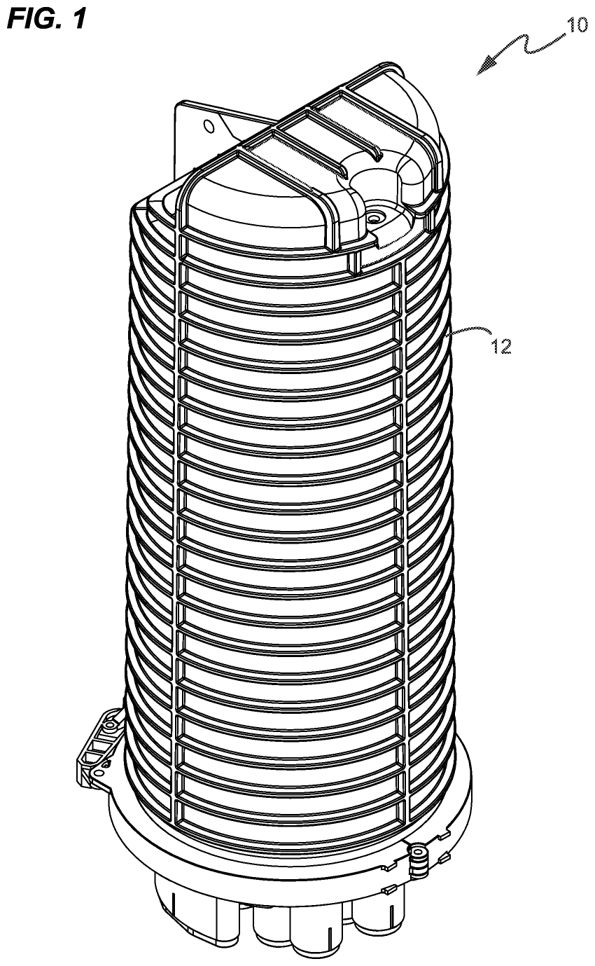

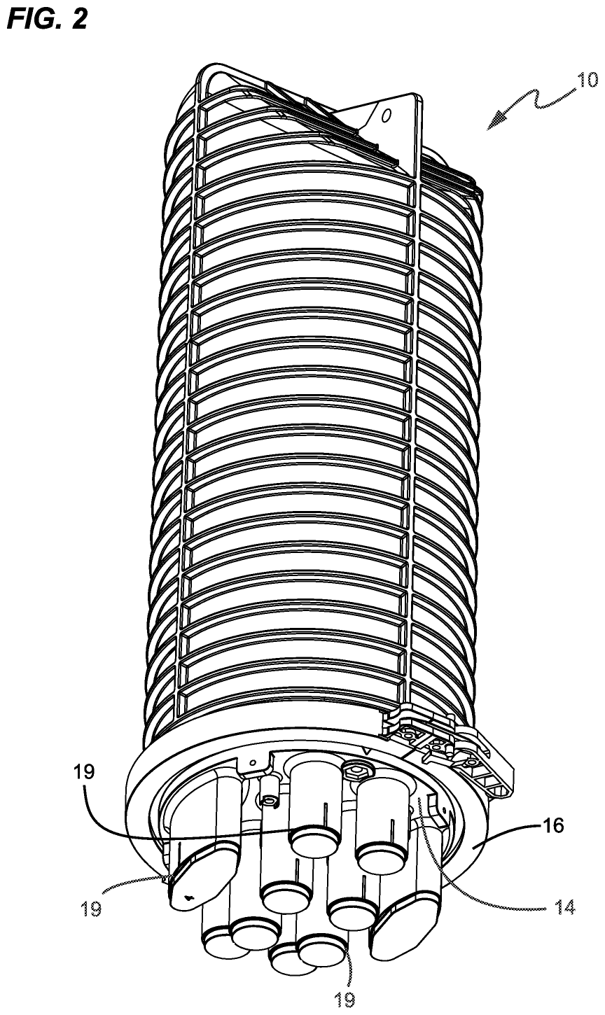

Referring to FIGS. 1-2, example telecommunications equipment 10 is shown. In the depicted example, the equipment 10 includes a sealable and re-enterable closure. In other examples, the equipment can include other components at a distribution location of an optical fiber network. Such equipment can include, for example, a cabinet, a drawer, a shelf, or a panel for organizing and routing optical fibers.

The closure 10 includes a first housing piece (or cover) 12 (in this case, a dome), and a second housing piece (or base) 14 configured to cooperate with the first housing piece to define a sealable and re-enterable telecommunications closure for managing optical fibers. The first and second housing pieces 12, 14 define a sealable and re-enterable interior closure volume in which other fiber managing equipment, including an optical fiber management assembly according to the present disclosure, can be positioned.

A clamp ring 16 having a clamp can be used to clamp and seal together the housing pieces 12 and 14.

Cables carrying optical fibers can enter the closure volume via sealable ports 19 defined by the second housing piece 14. Such cables can include trunk cables, feeder cables, branch cables, and distribution cables (also known as drop cables). Typically, optical fibers from one cable entering the closure are spliced to optical fibers of one or more other cables entering the closure to establish an optical signal path at the closure 10 (or other signal distribution equipment) from a provider side cable to one or more customer side cables, or an optical signal between a branch cable and any of: another branch cable, a trunk cable, a feeder cable, or a distribution cable. Branch cables can be used to route optical signals from one telecommunications closure to another telecommunications closure.

In addition to splicing, other fiber management activities can be performed with telecommunications equipment housed within the closure volume. Such activities can include, without limitation, indexing fibers, storing fibers (typically in one or more loops) and splitting fibers.

Splices, such as mechanical splices or fusion splices, can be performed at the factory or in the field, e.g., at the closure 10 positioned in the field.

The cables entering the closure can include optical fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Splice bodies can be used to protect the splices both in the case of individual fiber splices and mass fiber splices, such as mass fusion splices. The splice bodies are held in splice holders also known as splice chips. Fiber management trays of a fiber management assembly positioned in the interior sealable and re-enterable volume defined by the closure 10 can support such splice holders (or splice chips).

The fiber management assembly is connected to the base 14. The fiber management assembly can be assembled in multiple configurations. A particular configuration can be selected, e.g., by a technician, based on one or more factors concerning fiber management needs at the closure 10, while taking into consideration the limited space capacity of the interior volume defined by the closure 10.

For instance, according to a first example fiber management arrangement, all or a large majority of incoming fibers (e.g., from feeder cables and/or drop cables) are spliced at the closure to fibers of outgoing drop cables. That is, a relatively large number of active, outgoing drop cables are entering the closure volume. In this case, the splice supporting capacity of the closure's organizer must be maximized, while taking into account the space constraints of the closure volume. Thus, it can be advantageous to replace loop storage structures (such as a basket) of the organizer with additional fiber management trays that can support splices.

According to a second example fiber management arrangement, there are relatively few drop cables entering the closure volume and there is a need for the closure organizer to store loops of fiber slack for potential future active drop connections that are not presently needed. In this case, it can be advantageous to increase the loop storage capacity of the organizer, while taking into account the space constraints of the closure volume. Thus, it can be advantageous to replace fiber management trays of the organizer with a loops storage structure, such as a basket.

Even according to the first example fiber management arrangement described, it can be necessary to have some fiber slack management provided by the organizer that occurs off the fiber management trays. Thus, according to the first example fiber management arrangement described, the organizer can include a smaller profile slack management basket, but not a larger profile loop storage basket, while according to the second example fiber management arrangement, the organizer can include both a slack management basket and a loop storage basket.

The example organizer systems of the present disclosure are configured advantageously to allow selection and assembly of any of multiple fiber management arrangements, such as the different arrangements just described, while using many of the same assembly pieces, thereby improving the versatility of the system to adapt to different fiber management needs, while minimizing the number of assembly parts and minimizing the difficulty of converting from one arrangement to another arrangement as fiber management needs for a given closure change.

Each system of the present disclosure is configurable into different organizer assemblies, with each of the organizer assemblies having at least the following pieces and/or features in common: cable jacket fixation features, fiber management trays, and a support structure, such as a tower, for pivotally supporting the fiber management trays. Multiple of the organizer assemblies also include a slack management basket. At least one of the assemblies also includes a fiber loop storage basket.

Typically, a basket (such as a loop storage basket or another slack management basket) has a fixed position with respect to other pieces of the organizer. The fixed position of the basket can reduce the fiber management versatility of the organizer overall. Aspects of the systems of the present disclosure can improve the fiber management versatility of an organizer despite a fixed position of a basket within the organizer.

Generally, a loop storage basket is configured to store loops of optical fibers (such as inactive fibers or slack of active fibers). In some examples, the fiber loops stored in the fiber basket are protected in sheaths (e.g., elastomeric sheaths, or tubes, or woven sheaths), with each sheath loosely holding one or more optical fibers.

Generally, a slack management basket that is not a loop storage basket can be configured to store partial loops (e.g., U-shapes) of optical fibers. Such optical fibers can be sheathed or not sheathed. Such U-shapes can be useful for, e.g., simply routing a signal from an incoming feeder cable or branch cable to an outgoing branch cable without much excess slack. The U-shaped partial loop allows this routing to take place without bending the fiber beyond its minimum bend radius. Such U-shapes can also be useful, for e.g., redirecting an optical fiber from one side of the organizer to another side of the organizer without bending the fiber beyond its minimum bend radius. For example, if the fiber is not aligned with the correct entryway of a fiber management tray as it enters the closure, it can be redirected to the opposing entryway of the tray via a U-shaped path in the slack management basket.

Fibers extending from the ends of jacketed cables fixed to an organizer assembly can be in protective sheaths, and the bare fibers extend from the ends of the sheaths, from which they can be routed to a fiber management tray of the organizer assembly for splicing, splitting, or another fiber management operation.

Each fiber management tray supports splices of optical fibers and can also support other fiber management components, such as signal splitters. Some fiber management trays of a given organizer assembly can be configured and dedicated to support optical fiber splices, while one or more other trays can be configured and dedicated to support another fiber management function, such as signal splitting at one or more optical fiber signal splitters.

Aspects of the organizers of the present disclosure can improve organization of fiber management functions at a fiber management organizer of a telecommunications closure. For example, one or more splice management trays can be pivotally mounted at one side of a basket, while one or more signal splitting management trays can be pivotally mounted at the other side of the basket, providing a clear demarcation at the basket that defines a splicing zone on one side of the basket and a signal splitting zone on the other side of the basket, thereby enhancing overall efficiency and usability of the organizer.

The support structure (e.g., a tower) of the organizer assembly pivotally supports the fiber management trays in a stack of trays, facilitating access to each of the trays by allowing one or more trays to be pivoted away from the tray to which access is desired. A longitudinal axis of the tower is angled obliquely to the longitudinal axis of the enclosure such that multiple trays can be pivoted away from the stack without the trays' interfering with one other.

Pieces of the organizers described herein can be constructed of metal and/or polymeric materials. In some examples, one or more of the pieces are of unitary (e.g., seamless) construction. An organizer piece of unitary construction can be molded in a single molding operation.

As used herein, positioning and orientational terms such as up, down, upper, lower, above, below, front, back, rear, forward, backward, rearward, horizontal, vertical, proximal, distal, and so forth, may be used to refer to relative positioning of components in an assembly or portions of a component relative to each other when positioned in an assembly. Such terminology is provided as a descriptive aid and does not limit how components or portions of components may be positioned or oriented in practice.

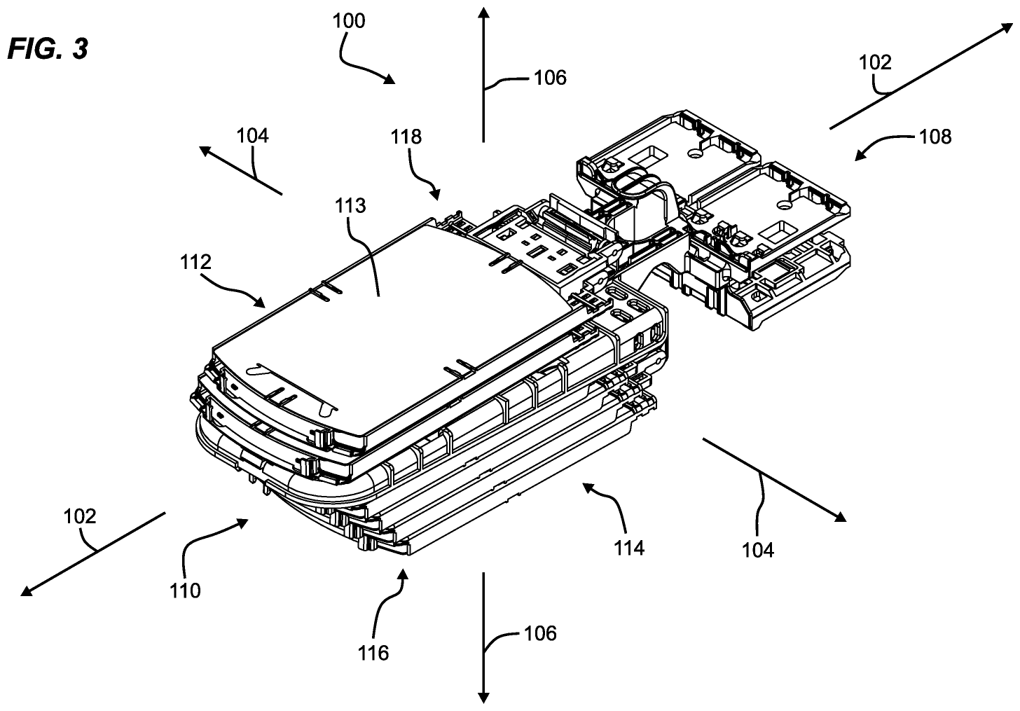

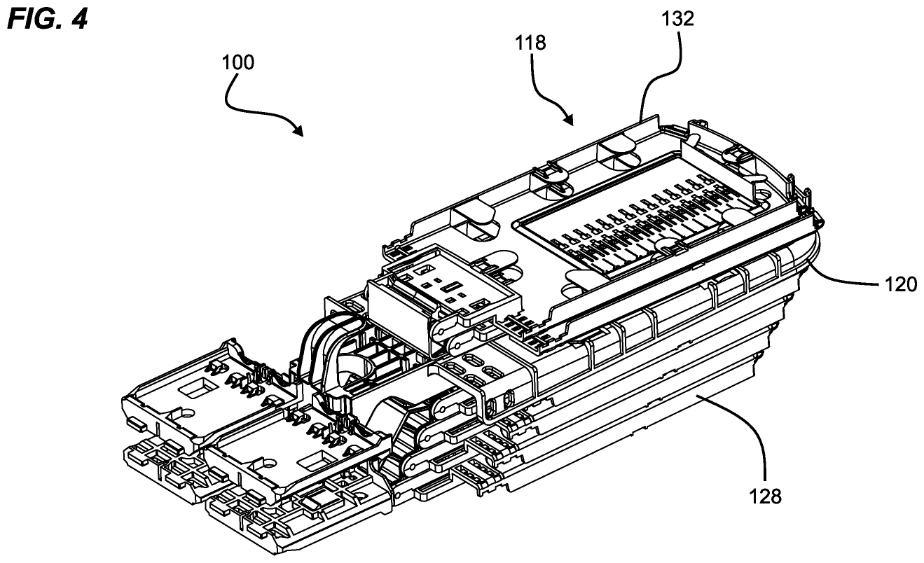

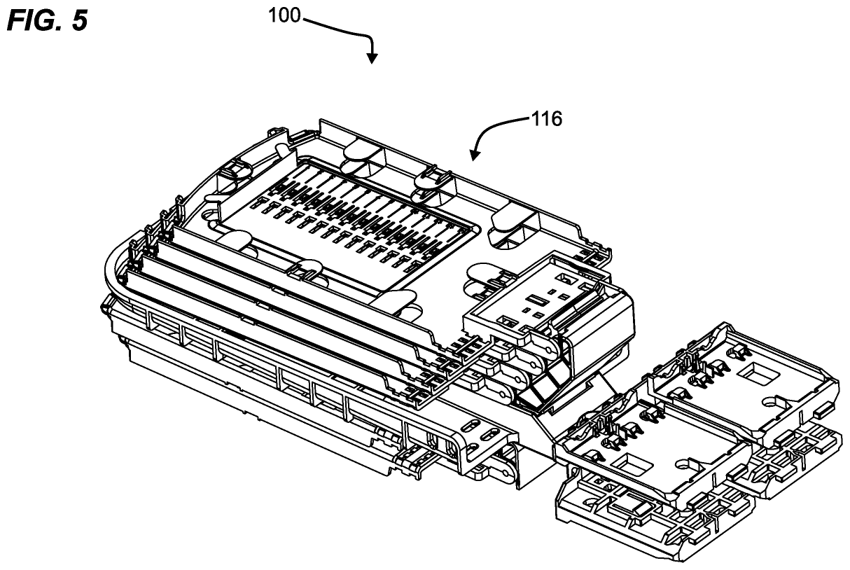

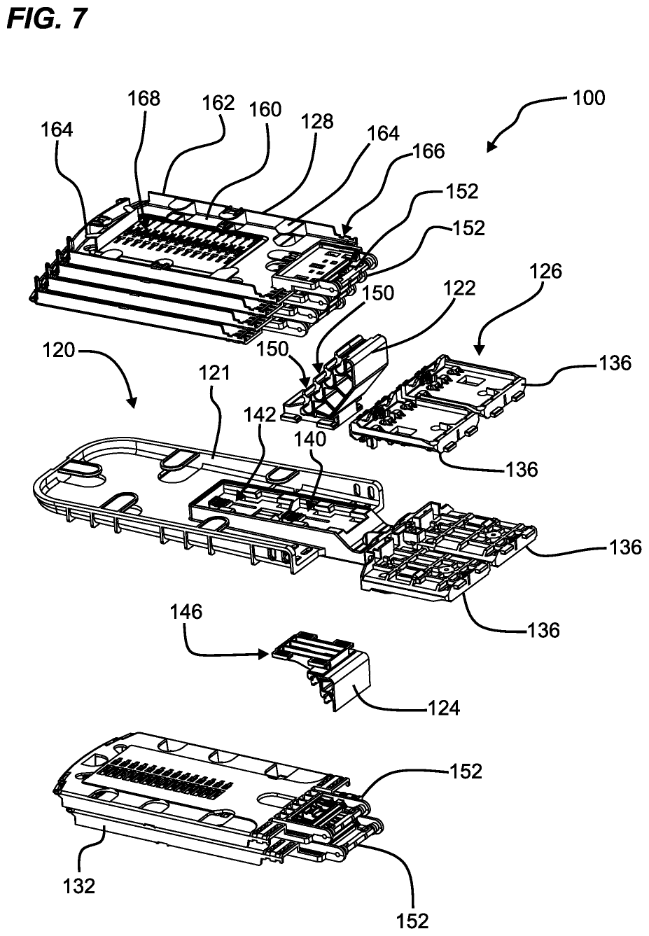

Referring to FIGS. 3-9, a first organizer configuration 100 of a system of the present disclosure is shown. The organizer configuration 100 can be housed in the closure 10 (FIG. 1).

The organizer configuration 100 (or, simply, “organizer”) extends from a proximal end 108 to a distal end 110 of the organizer along a first (longitudinal) axis 102. The organizer 100 extends from a first side 112 to a second side 114 of the organizer along a second axis 104. The organizer extends from a front 116 to a back 118 of the organizer along a third axis 106. The axes 102, 104 and 106 are mutually perpendicular to one another.

The organizer 100 is a configuration of a system of the present disclosure that is configured for increased splice and/or signal splitting capacity.

The organizer 100 includes a plurality of pieces configured to be snap-connected together to form the organizer 100.

In particular, the organizer 100 includes a main piece 120 of unitary construction. The main piece 120 includes plates 136. The plates 136 include structural features that can support cable jacket fixation subassemblies. Such subassemblies can anchor distal end portions of cable jackets, as well as the cables' strength member(s) to the piece 120, which can reduce lateral load impacts on delicate optical fibers emerging from the distal ends of the cable jackets.

The main piece 120 also includes a slack management basket 121.

The organizer 100 also includes a cable fixation piece 126 that includes two additional plates 136. The piece 126 is configured to snap-connect to the piece 120, thereby forming back-to-back pairs of the plates 136 configured to align with different cable entry points into the closure volume.

The organizer 100 also includes a first (or front) tower 122 and second (or back) tower 124. The front tower 122 is configured to pivotally support up to four fiber management trays, such as the front trays 128 in a stack 130. The back tower 124 is configured to pivotally support up to two fiber management trays, such as the back trays 132 in a stack 134.

Optionally, each tray 128, 132 can be provided with a snap-on cover 113 (shown in FIG. 3). Such a cover 113 can be removed and reinstalled as needed, and, when installed, can protect the optical fibers managed on the tray and/or serve as a fiber retainer that helps to retain the fibers within the interior tray volume.

Depending on the size of the front trays, the front tower 122 is configured to be slid parallel to the axis 102 into snap-connection at either a first mounting location 140 or a second mounting location 142 of the basket 121, which mounting locations are both accessible at the front side of the basket 120. The back tower 124 is configured to be slid parallel to the axis 102 into snap-connection at a third mounting location 144 that is accessible at the back side of the basket 121. More specifically, each of the towers 122, 124, includes a mounting interface 146 that is complementary to a mounting interface defined by each of the mounting locations 140, 142, 144.

Each tower 122, 124, includes a body 147, 148 extending away from the mounting interface 146. The body 147, 148 defines sockets 150 each configured to pivotally receive and support a pivot pin 152 of a tray 128, 132. The tower 122 defines four of the sockets 150. The tower 124 defines two of the sockets 150. The sockets 150 of each tower 122, 124 are arranged along an axis that, when the organizer 100 is assembled, is oblique to the axis 102 and oblique to stacking axes along which the stacks 130 and 134 are stacked. This arrangement of the sockets 150 improves access to trays in the stack 130, 134 by keeping trays that have been pivoted out away from the axis 102 farther from the tray that is being accessed to perform fiber management.

The front trays can be configured the same as, or differently from, the back trays. In the example shown, the front trays 128 and the back trays 132 are of identical configuration. Each tray 128, 132 includes a fiber management surface 160, and one or more walls 162 that projects away from the surface 160 about a portion of the outer perimeter of the surface 160. Fiber retaining lips 164 extend from the wall(s) 160 and are configured to retain looped fiber between the lips 164 and the surface 160. Two entryways 166 at opposite sides of the tray 128, 132 allow fibers from two different cables to enter the tray and operatively couple to each other on the tray, e.g., in the form of a splice or at a splitter. Each tray 128, 132 defines a fiber management component region 168 which includes structures for mounting splice holders (such as splice chips), signal splitters, or other fiber management components. The interfacing between the pins 152 and the sockets 150 can be such that a tray 128, 132 can hold (e.g., by friction) in a pivoted out position until enough force is applied to pivot the tray back to the stacked position. Each tray 128, 132 can also include additional features that can serve as pivot stops for the trays at one or more pivoted out positions.

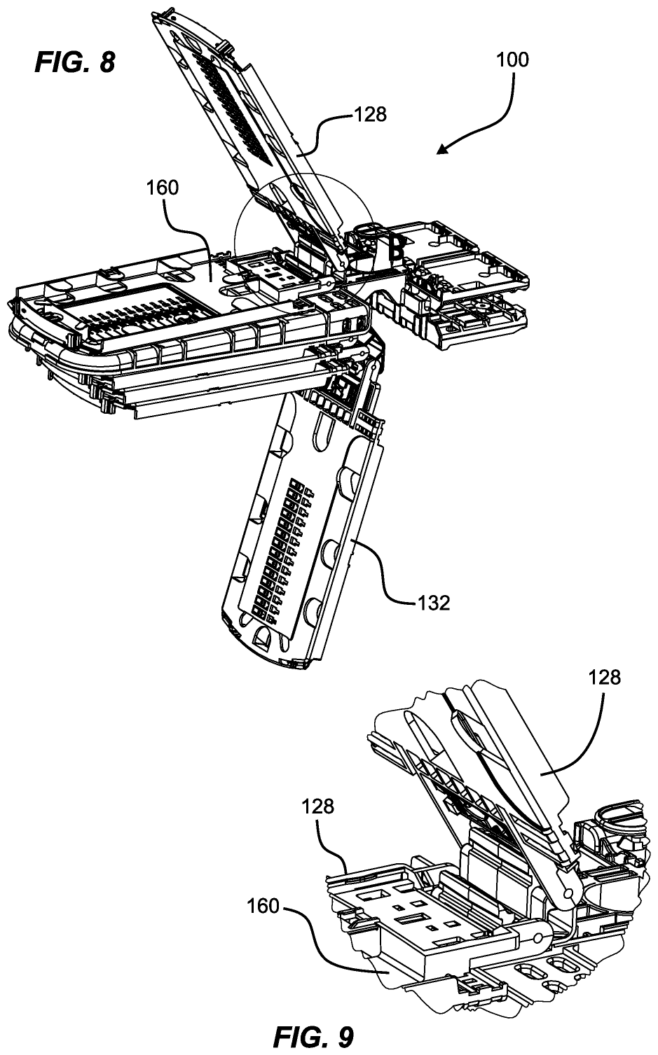

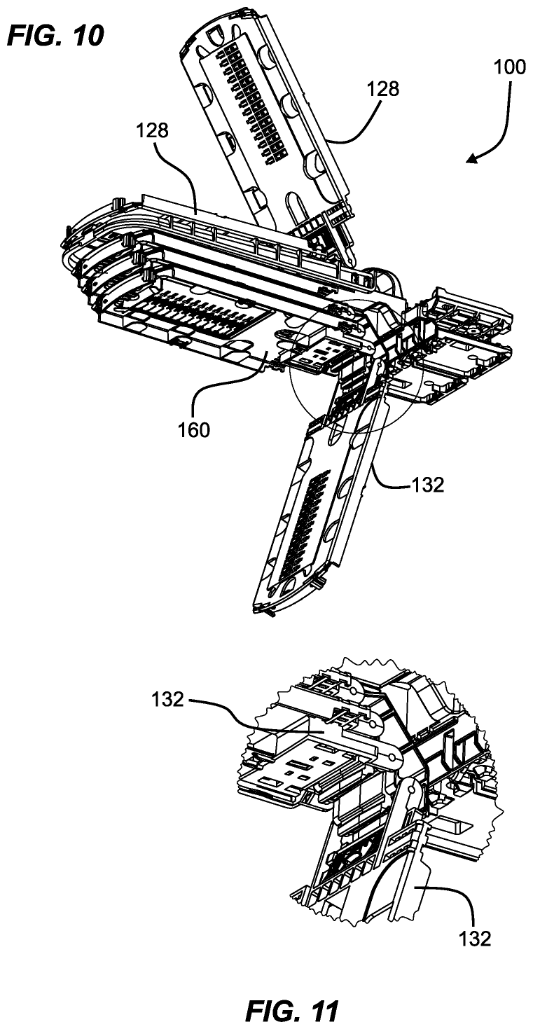

Referring to FIGS. 8-11, the organizer 100 is shown with one of the front trays 128 and one of the back trays 132 pivoted out (i.e., away from the axis 102), thus providing access to the fiber management surface 160 of the next tray 128, 132 in the stack 130, 134.

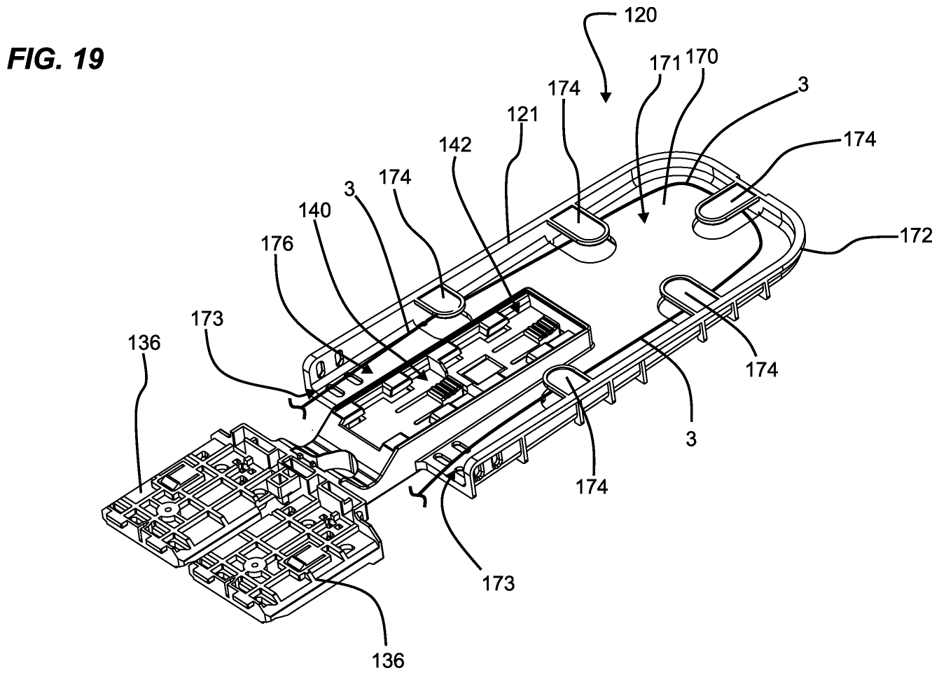

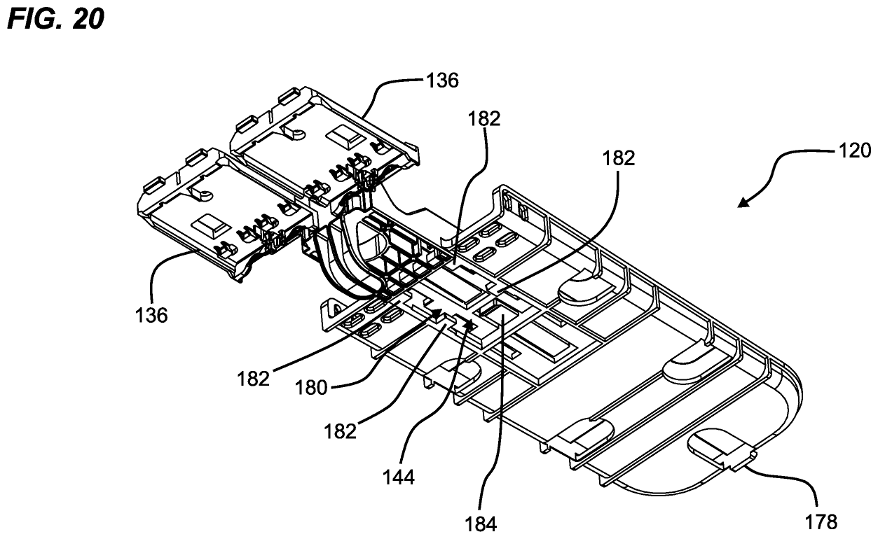

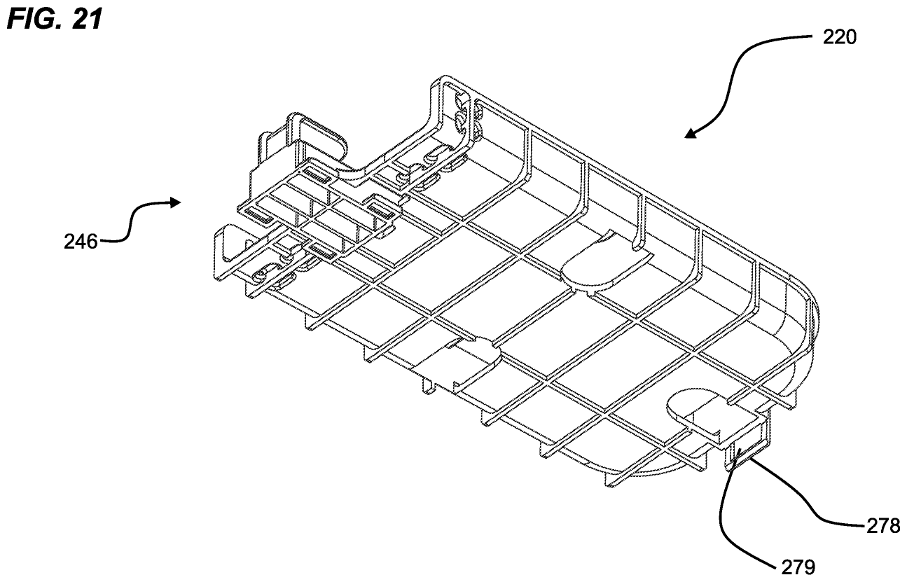

Referring to FIGS. 19-20 additional features of the piece 120 will be described. The slack management basket includes a main fiber support surface 170 and a wall 172 projecting away from the surface 170 around a portion of the perimeter of the surface 170, defining entryways 173 at opposite sides of the basket 121 for sheathed or unsheathed fibers to enter and exit the basket 121. The surface 170 and the wall 172 defined a basket volume 171 in which fibers can be routed and stored. An example fiber 3 (or sheathed fiber) is schematically shown (FIG. 19) entering and exiting the basket 121 via the entryways 173 and forming a U-shape in the basket volume 171 between the surface 170 and fiber retaining lips 174 that project from the wall 172. Example functions of such a U-shape routing path are described above.

The basket 121 includes a mounting region 176 within the U-shaped path defined by the surface 170. The mounting region 176 includes the mounting locations 142 and 144. Each mounting location 142, 144 is adapted to slidingly and snappingly receive a complementary mounting portion of another piece, such as a tower, or another basket, as described more fully below.

The basket 121 also includes a latch 178 at a distal end of the basket 121. The latch 178 can be used to secure another piece, such as another basket to the basket 121.

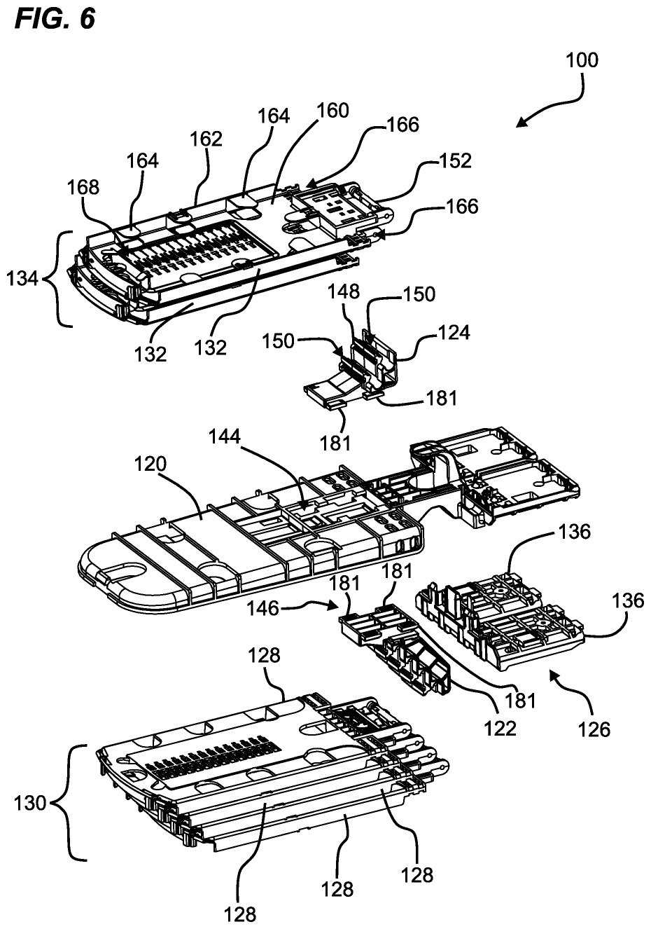

The basket 121 also includes the back mounting location 144. The back mounting location 144 has structural and mechanical features similar or identical to the mounting locations 140 and 142, and so the same complementary interface of another piece can be slidingly snapped at the mounting location 144 as at either of the mounting locations 140 or 142. In particular, the mounting location 144 includes a pocket 180, retainers 182, and a resilient latch arm 184. A complementary mounting portion (e.g., the mounting portion 146 or a similar mounting portion of another piece, such as a basket) is inserted into the pocket 180, causing the latch arm to flex towards the front of the basket 121. Then, the complementary mounting portion is slid proximally until the catch snappingly engages a shoulder or other portion of the complementary mounting portion and flanges 181 (FIG. 6) of the mounting portion are retained along the front to back dimension within the pocket 180 by the retainers 182. Flexing of the latch arm 184 allows the mounted piece to be removed from the basket 121 so that a different piece, can be mounted to the same mounting location 140, 142, 144.

The organizer 100 has up to six trays, including up to four front trays 128 (e.g., one, two, three, or four front trays), up to two back trays 132 (e.g., one back tray or two back trays), and two towers 122 and 124. In theory, an organizer with a single tower that could pivotally support six trays would have the same fiber management capacity as the organizer 100. However, such a theoretical organizer would not be as versatile as the organizer 100. For example, the piece 120 (and the basket 121) are configured to support fiber managing components at the both the front and the back. As a result, the basket 121 can server as an organization demarcation between, e.g., different types of fiber management. For instance, the front trays 128 can be configured to support splices (with one or more splice holders mounted to the trays 128) while the back trays 132 can be configured to support signal splitters (with one or more splitter holders mounted to the trays 132).

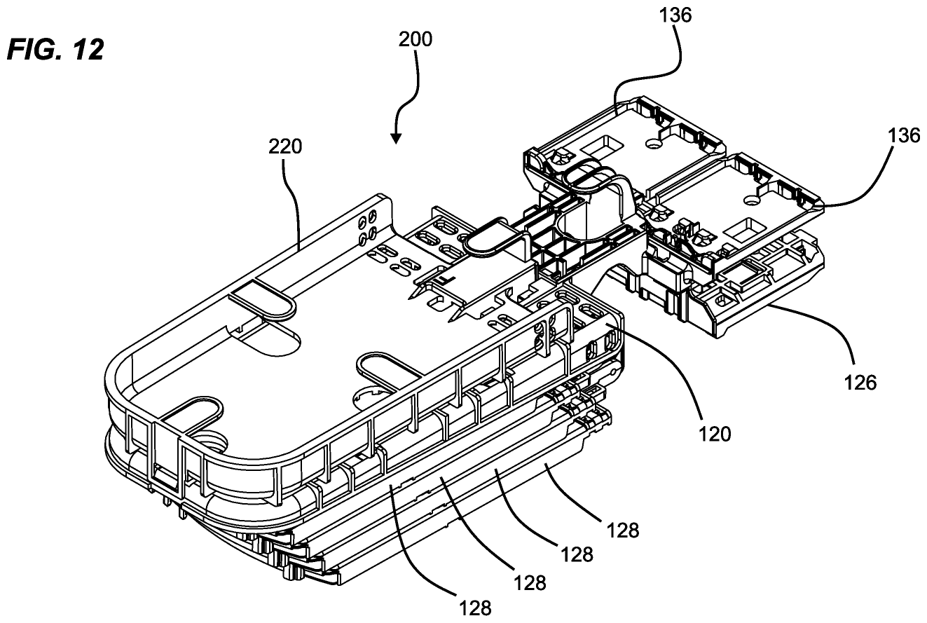

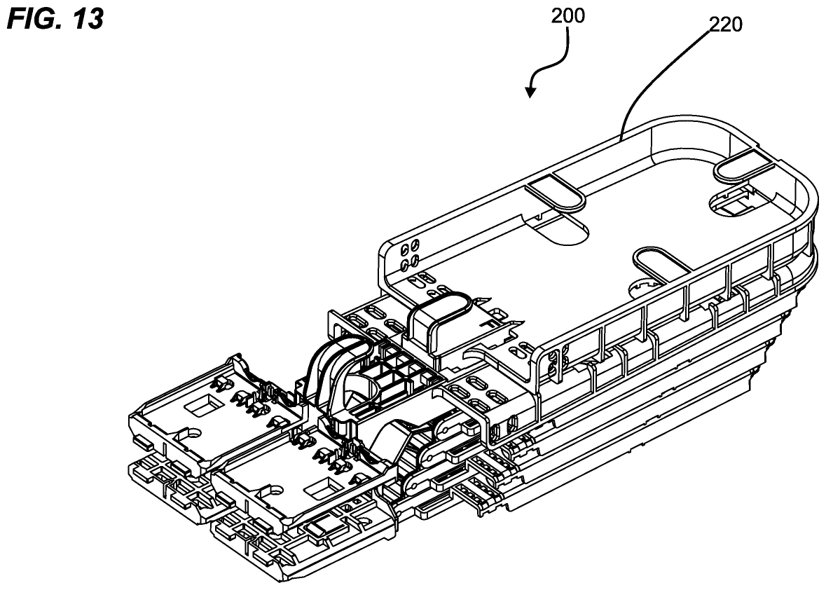

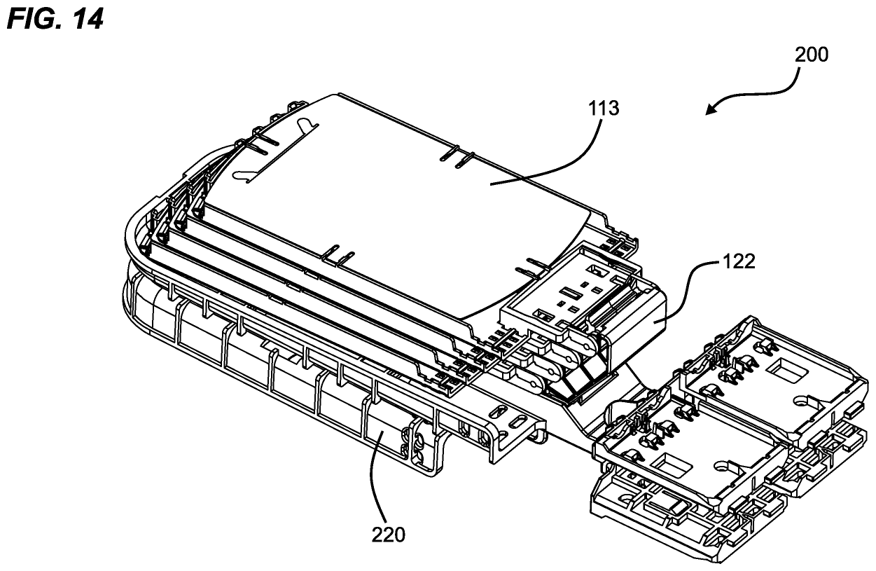

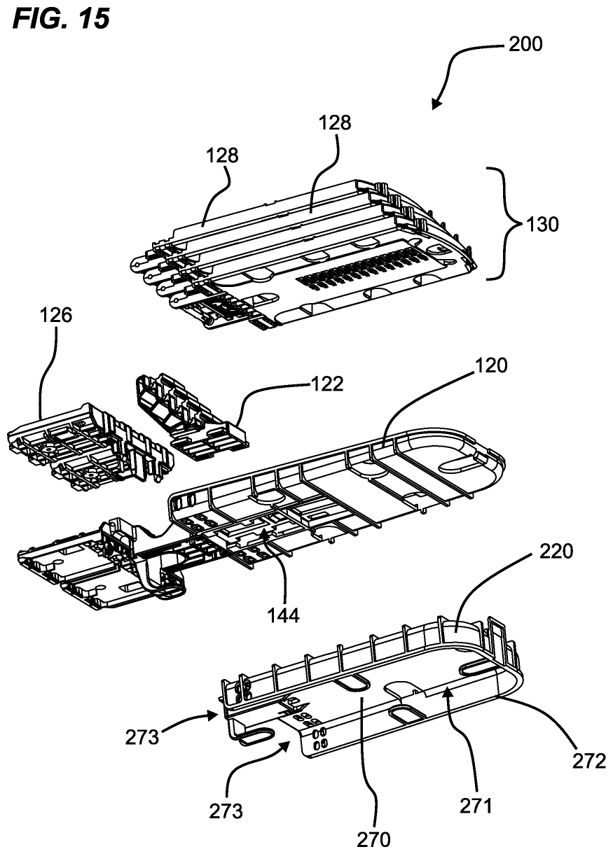

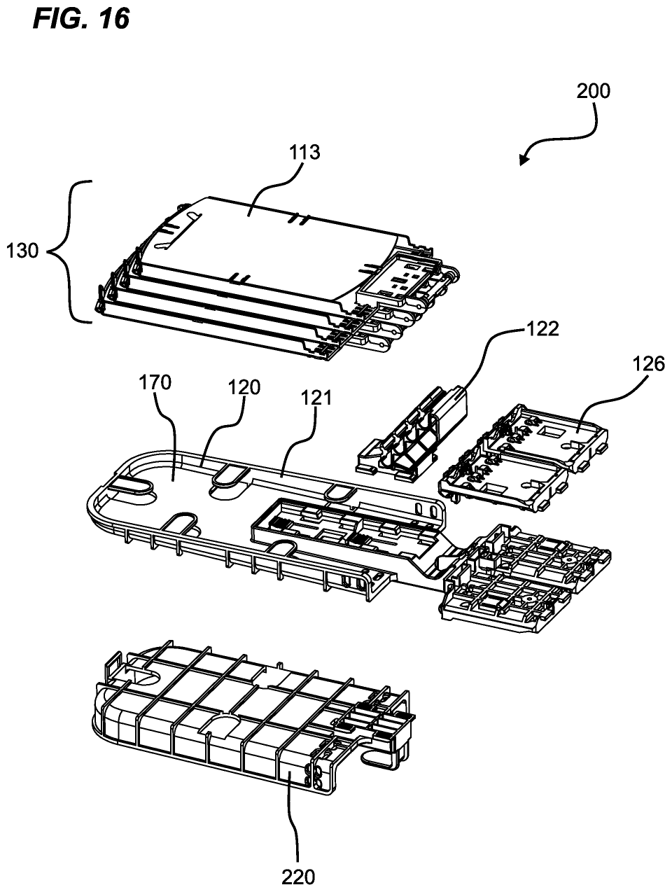

As another example, because the basket 121 includes mounting locations at the front and the back, a tray supporting tower can be mounted to one of the front and the back, while a different kind of component, such as a loop storage basket, can be mounted to the other side of the basket. One configuration embodying this example is depicted in FIGS. 12-18.

In addition to the advantages just described, it can be further advantageous to provide a basket to which fiber management components can be mounted to both the basket front and the basket back because the basket of an organizer can be the piece of the assembly that extends the farthest distally. For instance, in the case of a tapered dome of a closure, such as the housing piece 12 (FIG. 1), the interior volume of the closure can be maximized if the basket is centered or close to centered within the closure volume. A basket that provides for fiber management structures on both front and back can be better centered in the closure volume.

Referring to FIGS. 12-18 and 21, another organizer configuration 200 (or simply, “organizer”) of a system of the present disclosure will be described. The organizer 200 includes some of the same pieces as the organizer 100. Thus, it will be appreciated that converting between the organizers 100 and 200 can be done easily, by swapping a minimum number of pieces.

The organizer 200 includes the piece 120 and the piece 126 that snap-connects to the piece 120. The organizer 200 includes the tower 122 that snap-connects at one of the mounting locations at the front of the basket 121 of the piece 120. The organizer 200 includes the stack 130 of up to four front trays 128 pivotally mounted to the tower 122.

However, instead of a back tower 124 and back trays 132 as in the organizer 100, in the organizer 200 those components have been swapped for a fiber loop storage basket 220. The fiber loop storage basket 220 mounts directly to the basket 121 at the mounting location 144. That is, the basket 220 is configured to mount at the same location as the tower 124 in the organizer 100. When mounted to the basket 121, the basket 220 and the basket 121 are back-to-back in the sense that their main fiber support surfaces 170, 270 that define their respective basket volumes 171, 271 face away from each other.

Because the baskets 121 and 220 are back-to-back, the respective basket volumes can both be accessed easily. That is, one basket does not block or obstruct access to the other basket.

The basket 220 includes a tab 278 at a distal end of the basket 220. The tab 278 defines an opening 279 that snappingly receives the latch 178 of the basket 121 to provide additional structural connection between the baskets 121 and 220. The basket 220 includes a mounting portion 246 that is structurally similar and functionally identical to the mounting portion 146 of the towers 122 and 124 described above. Thus, there are two mating interfaces between the baskets 121 and 220 that are offset from each other along a reference line parallel to the axis 102, including a mating interface between the mounting location 144 and the complementary mounting portion 246 of the basket 220, and a mating interface between the latch 178 and the tab 278.

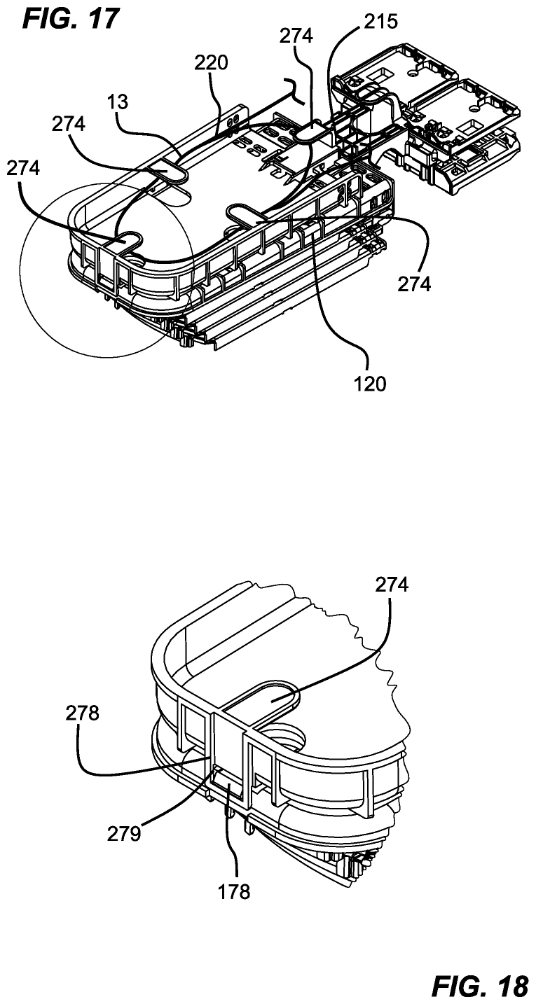

The basket 220 includes the main fiber support surface 270 and a wall 272 projecting away from the surface 270 around a portion of the perimeter of the surface 270, defining entryways 273 at opposite sides of the basket 220 for sheathed or unsheathed fibers to enter and exit the basket 220. The surface 270 and the wall 272 defined a basket volume 271 in which fibers can be routed and stored. An example fiber 13 (or sheathed fiber) is schematically shown (FIG. 17) entering and exiting the basket 220 via the entryways 273 and forming one or more loops in the basket volume 271 between the surface 270 and fiber retaining lips 274 that project from the wall 272 and from a lip support 275.

As compared with the organizer 100, the organizer 200 can be better suited for to handle fewer active drop cable connections and more loop storage for future connectivity. The organizer 100 can be converted to the organizer 200 and vice versa when fiber management needs at the assembly change, by swapping the basket 220, and the back tower 124 and back trays 132.

It will be appreciated that according to another configuration of either organizer 100 or 200, nothing is mounted to the back side of the basket 121.

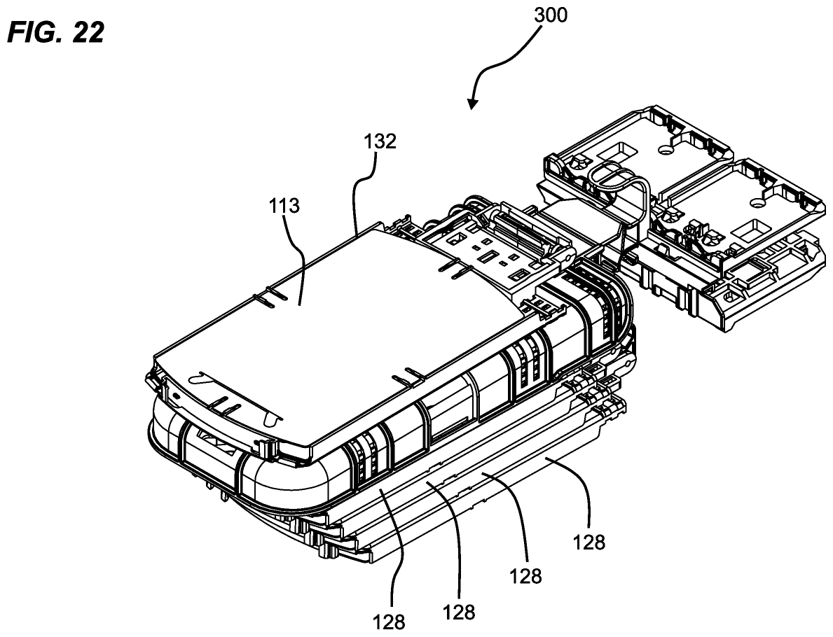

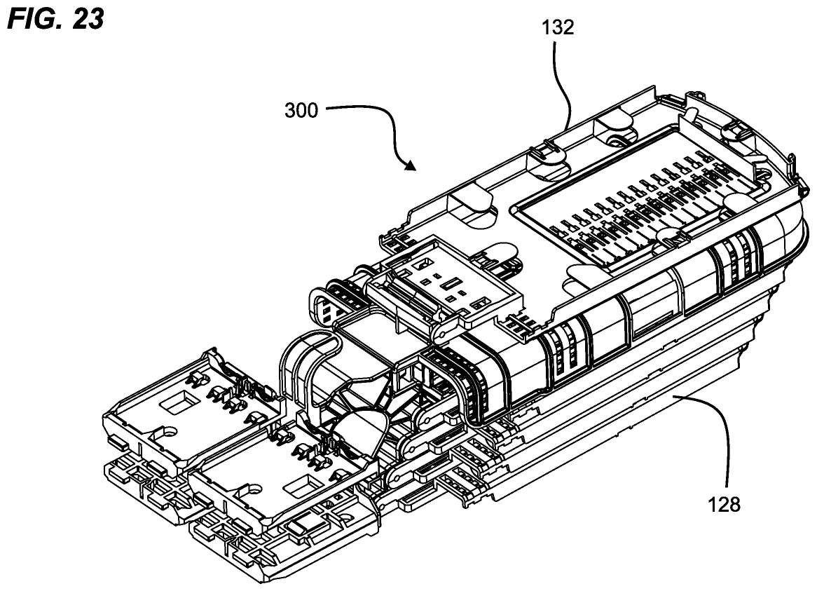

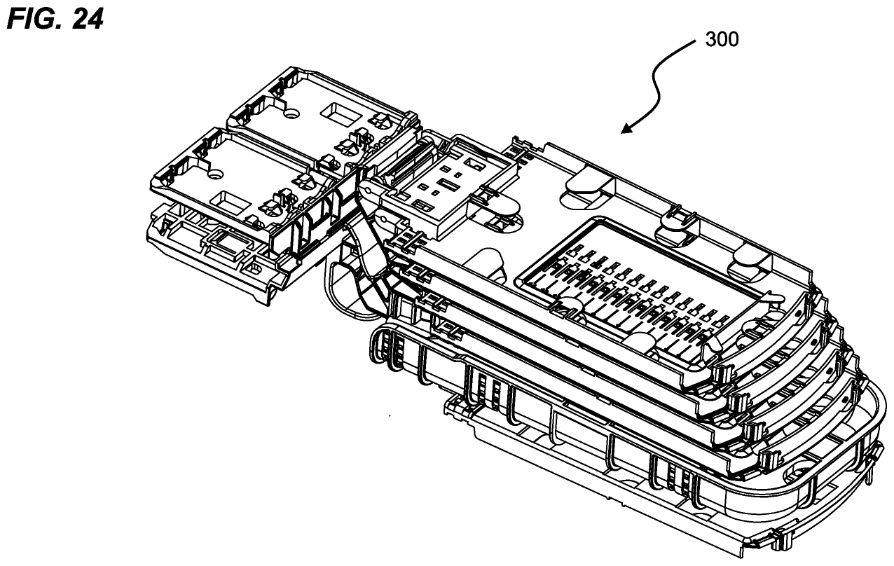

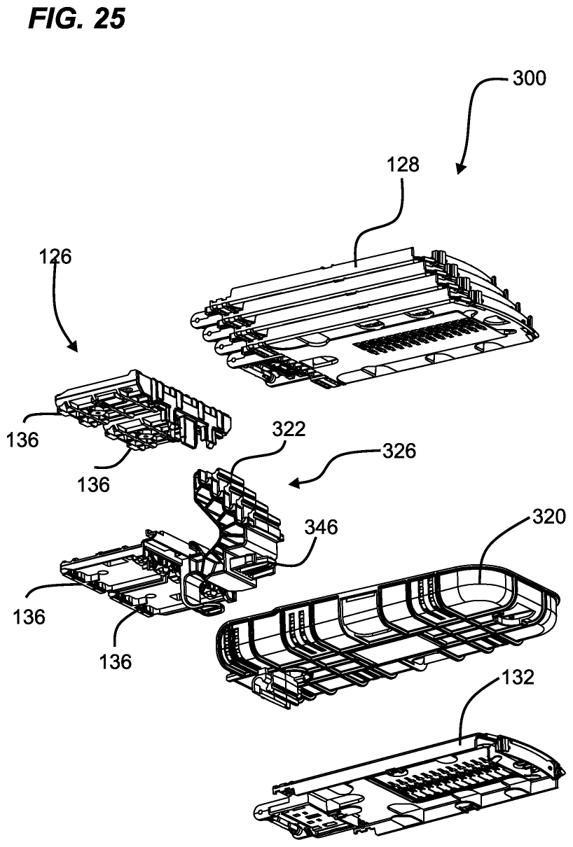

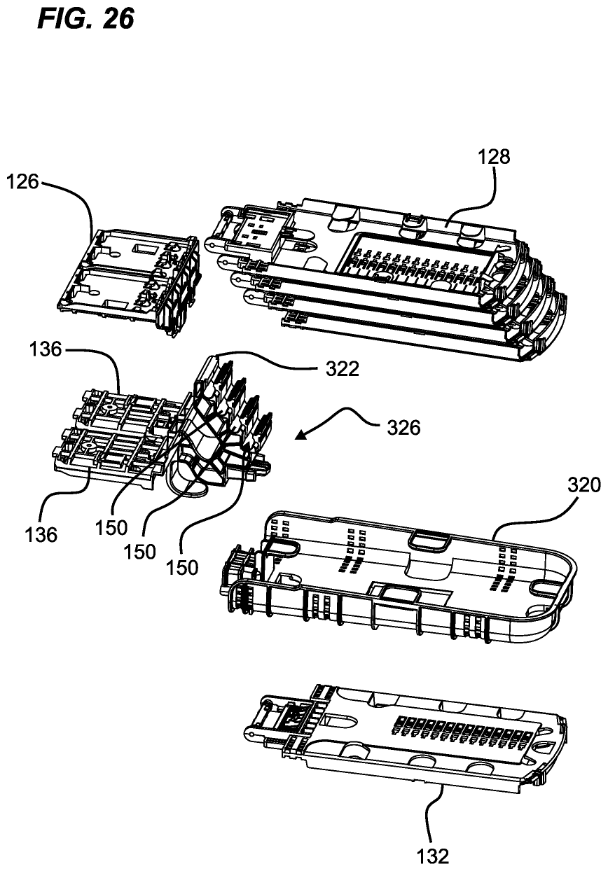

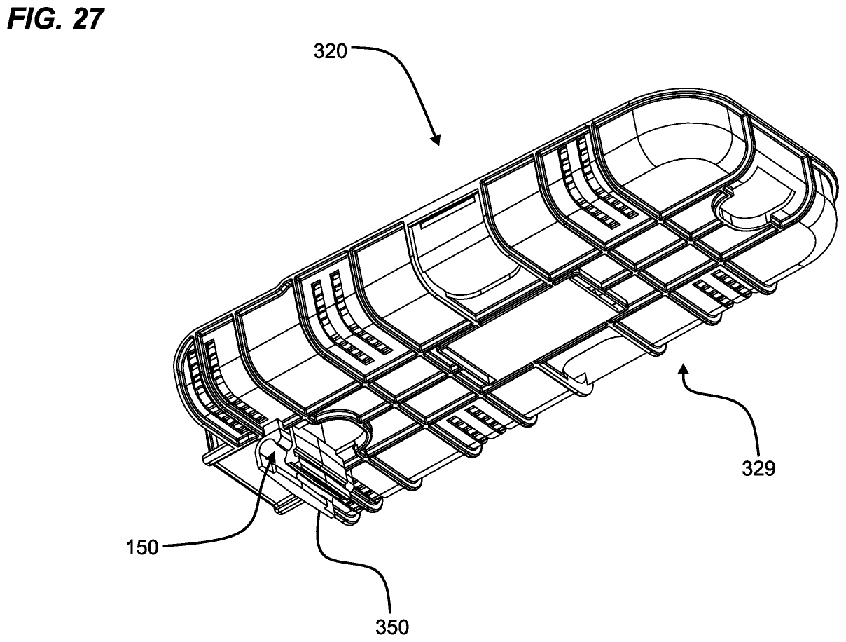

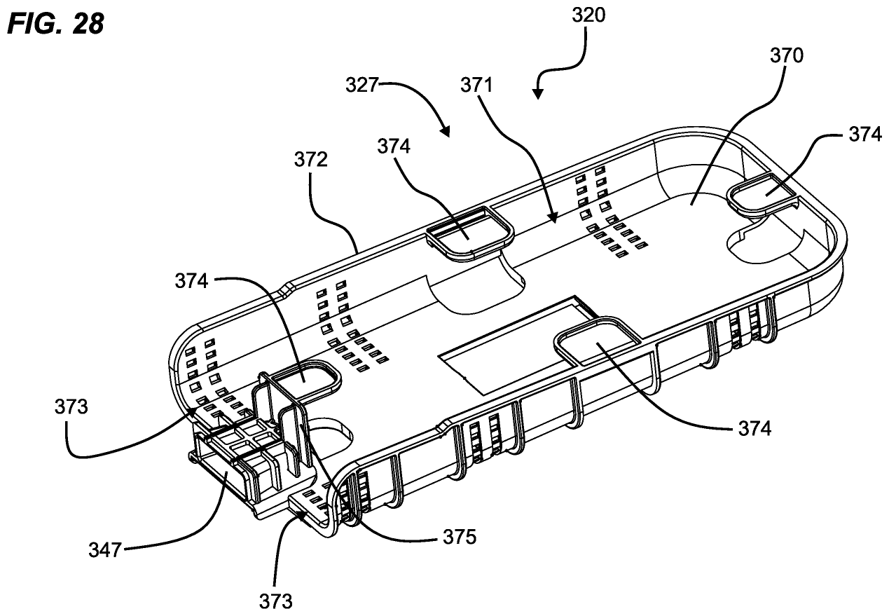

Referring to FIGS. 22-28, an organizer configuration 300 (or, simply, “organizer”) will be described. The organizer 300 provides an alternative mechanism for pivotally mounting a fiber management tray (or another component) relative to a basket. The organizer 300 is configured to be housed in a closure, such as the closure 10 (FIG. 1).

The organizer includes a piece 326 of unitary construction. The piece 326 includes a tower 322, cable fixation plates 136, and a coupler 346. The organizer includes a piece 126 that snap-connects to the piece 326. The organizer includes up to four front trays 128 that pivotally mount to the tower 322, which defines sockets 150.

The organizer includes a loop storage basket 320. The loop storage basket 320 includes a socket 347 that snappingly receives the coupler 346 to connect the basket 320 and the piece 326 to each other. Once connected, the trays 128 are positioned at a front side of the basket 320.

The basket 320 includes a main fiber support surface 370 and a wall 372 projecting away from the surface 370 around a portion of the perimeter of the surface 370, defining entryways 373 at opposite sides of the basket 320 for sheathed or unsheathed fibers to enter and exit the basket 320. The surface 370 and the wall 372 defined a basket volume 371 in which fibers can be routed and stored. Such sheathed or unsheathed fibers can enter and exit the basket 320 via the entryways 373 and forming one or more loops in the basket volume 371 between the surface 370 and fiber retaining lips 374 that project from the wall 372 and from a lip support 375.

The basket 320 includes a front side 327 at which the basket volume 371 is accessible, and a back side 329 from which the basket volume 371 is not accessible. At the back side 329, the basket 320 includes a mounting portion 350 that projects rearward from a bottom surface of the basket 320 and away from the surface 370. The mounting portion 350 defines a socket 150 which is configured to pivotally mount another component, such as another basket (not shown), or a back tray 132. Thus, the basket 320 is configured to directly pivotally mount a fiber management tray.

The tower 322 and the mounting portion 350 can together be used to create different organizer configurations, with pivoting trays at a front side of the basket 320, and either a bottom tray 132, another basket, or neither at a back side of the basket 320. Also in this matter, the basket 320 can serve as a demarcation between different fiber management functions, such as front trays that are used for supporting splices and a back tray that is used for supporting signal splitting components.

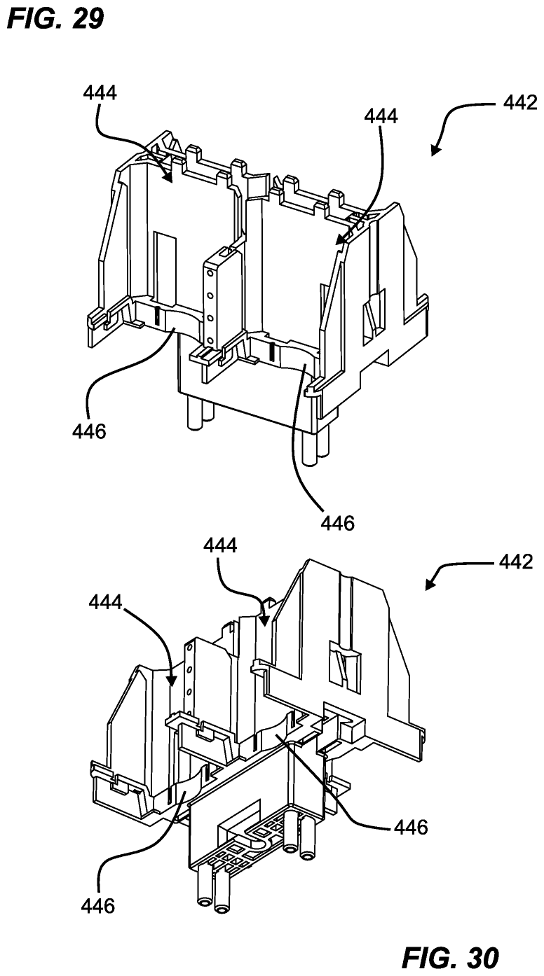

Referring to FIGS. 29-30, an example base piece 442 is depicted. The base piece 442 is configured to mount the organizer 100, 200, or 300 and to be received within the closure volume of, e.g., the closure 10. For example, the base piece 442 defines pockets 444 that can receive via snap-lock interface the plates 136 of the organizers 100, 200, 300. In addition, the base piece 442 defines receivers 446 configured to receive sealing blocks. Such sealing blocks can seal about cable jackets as the cables enter the closure and are fixed to the plates 136.

Various modifications and alterations of this disclosure will become apparent to those skilled in the art without departing from the scope and spirit of this disclosure, and it should be understood that the scope of this disclosure is not to be unduly limited to the illustrative examples set forth herein.

1. An optical fiber management organizer for a telecommunications closure, comprising:
a first basket for storing loops or partial loops of optical fibers;
optical fiber management trays configured to be pivotally mounted at a first side of the first basket; and
a second basket for storing loops or partial loops of optical fibers, the first basket and the second basket being configured such that the second basket can be mounted directly to a second side of the first basket at a first mounting location, the second side being opposite the first side.

2. The organizer of claim 1, wherein the first basket and the second basket are configured such that when the second basket is mounted directly to the second side of the first basket a basket volume defined by the first basket and a basket volume defined by the second basket are back-to-back.

3. The organizer of claim 1,
wherein the first basket is configured to store optical fibers in U-shapes; and
wherein the second basket is configured to store optical fibers in full loops.

4. The organizer of claim 1, further comprising a tower configured to mount to the first mounting location, the tower being configured to pivotally support at least one other fiber management tray at the second side of the first basket.

5. The organizer of claim 1,
wherein the first basket includes a second mounting location at the first side of the basket;
wherein a tower is mounted to the basket at the second mounting location; and
wherein the optical fiber management trays are pivotally mounted to the tower.

6. The organizer of claim 1, further comprising plates for mounting cable jacket fixation subassemblies.

7. The organizer of claim 6, wherein the plates and the first basket form a single piece of unitary construction.

8. A telecommunications closure, comprising:
housing pieces configured to cooperate to define a sealable and re-enterable closure volume; and
the organizer of claim 1 housed in the closure volume.

9. An optical fiber management organizer for a telecommunications closure, comprising:
a basket for storing loops or partial loops of optical fibers;
a first optical fiber management tray configured to be pivotally mounted at a first side of the basket; and
a second optical fiber management tray configured to be pivotally mounted at a second side of the basket, the second side being opposite to the first side,
wherein the first optical fiber management tray is configured to support optical fiber splices and does not support an optical fiber signal splitter; and
wherein the second optical fiber management tray is configured to support an optical fiber signal splitting component.

10. A method, comprising:
providing the fiber management organizer of claim 9;
routing optical fibers via splices supported on the first optical fiber management tray;
routing optical fibers via a signal splitting component supported on the second optical fiber management tray; and
performing no signal splitting of optical fibers on the first optical fiber management tray.

11. An optical fiber management organizer system, comprising:
an optical fiber organizer configurable into each of a first configuration and a second configuration, each of the first configuration and the second configuration including:
a first basket for storing loops or partial loops of optical fibers; and
a first optical fiber management tray pivotally mounted at a first side of the first basket,
wherein in the first configuration a second basket for storing loops or partial loops of optical fibers is mounted at a second side of the first basket, the second side being opposite the first side; and
wherein in the second configuration a second optical fiber management tray is pivotally supported at the second side of the basket.

12. A method of using the system of claim 11, comprising:
selecting the first configuration or the second configuration based on a number of telecommunications cables and/or a type of telecommunications cables entering a telecommunications closure to provide a selected configuration; and
configuring an organizer according to the selected configuration.

13. The method of claim 12, further comprising:
prior to the selecting, providing the other of the first configuration and the second configuration that is not the selected configuration,
wherein the configuring includes swapping a piece of the other of the first configuration and the second configuration with another piece.

14. The method of claim 13, wherein the swapping includes swapping, with each other, a basket, and a tower configured to pivotally support at least one optical fiber management tray.

15. The system of claim 11, wherein the first basket and the second basket are configured such that when the second basket is mounted at the second side of the first basket according to the first configuration, a basket volume defined by the first basket and a basket volume defined by the second basket are back-to-back.

16. The system of claim 11,
wherein the first basket is configured to store optical fibers in U-shapes; and
wherein the second basket is configured to store optical fibers in full loops.

17. The system of claim 11,
wherein each of the first configuration and the second configuration includes a first tower mounted directly to the first basket at the first side of the first basket and pivotally supporting the first optical fiber management tray; and
wherein the second configuration includes a second tower mounted directly to the first basket at the second side of the first basket and pivotally supporting the second optical fiber management tray.

18. The system of claim 11, wherein each configuration includes plates for mounting cable jacket fixation subassemblies.

19. The system of claim 18, wherein the plates and the first basket form a single piece of unitary construction.

20. A telecommunications closure, comprising:
housing pieces configured to cooperate to define a sealable and re-enterable closure volume; and
one of the first configuration and the second configuration of the system of claim 10 housed in the closure volume.
